(19) United States
(12) Patent Application Publication
(10) Pub. No.: US 2026/0284990 A1
(43) Pub. Date: Sep. 24, 2026

(54) ONE-PIECE EYEGLASS OR MASK PARTS FROM MOLD AND PROCESS FOR MAKING THEM

(71) Applicant: LUXOTTICA S.R.L., Agordo (BL) (IT)

(72) Inventors: Vincenzo SPREMULLI, San Clemente, CA (US); Pietro FRIGENI, Agordo (BL) (IT); Fabio FERRACANE, Chieri (TO) (IT)

(73) Assignee: LUXOTTICA S.R.L., Agordo (BL) (IT)

(21) Appl. No.: 19/469,271

(22) PCT Filed: Mar. 22, 2024
(86) PCT No.: PCT/IB2024/052777

§ 371 Date: Sep. 25, 2025

(30) Foreign Application Priority Data
Mar. 27, 2023 (IT) 102023000005772

(51) Int. Cl. B29D 11/00; B29D 12/02

(52) U.S. Cl. CPC B29D 11/00009; B29D 12/02

(57) ABSTRACT

Parts of eyeglass or mask, and method thereof, made of one-piece by a single injection molding or casting step, in bio-polymer or plastic monomaterial equal for all the parts of the eyeglass or mask. The parts include lenses, and/or nose pads or nosepieces, end pieces for coupling temples, a bridge, a front of the eyeglass frame or mask, and hinges and/or hinging elements. Contiguous areas of different thickness are provided, sized so that the area with higher thickness differs from that with lower thickness by a maximum value of between 1.5 mm and 6 mm, the contiguous areas being joined by a junction having a radius of curvature between 0.5 and 5 mm.

The present invention refers to one-piece eyeglass or mask parts.

The invention further refers to a method for making said eyeglass or mask parts.

In more detail, the invention relates to eyeglass or mask parts providing a single element which includes at least the frame, the lenses and possibly the nose pads, up to the hinging point of the temples, and the hinge itself.

Hereinafter, reference will be generally made to an eyeglass, but it should be understood that the same considerations apply to a mask.

Solutions which tried to make one-piece eyeglass or mask parts are already known in the art.

However, none of said solutions allows to obtain the desired result, as none of the solutions allows to make one-piece eyeglass or mask parts, including the lenses, the nose pads, and the frame itself.

Some of these solutions, which are not capable of solving the problem anyway, are described in U.S. Pat. No. 3,526,449 and Patent EP3399365.

In more general terms, fronts for eyeglasses or masks, made of one-piece, wherein the lenses are subsequently added, or front assemblies and lenses made of one-piece, to which the pads and/or the nose bridge are added subsequently, are known in the art.

Masks (e.g., Oakley Kato), wherein the other components, such as the nosepieces made of rubber or plastic material and/or the temples, are subsequently added to the mask, made of one-piece, are still known in the art.

Furthermore, eyeglasses, in particular for children, are known, whose frame is entirely made of one-piece and of monomaterial (e.g., rubber), to which the lenses are subsequently added. They are made of particularly flexible material, not suitable for the eyeglasses and/or masks for general use, and in particular for adults, which must necessarily have resistance and solidity features.

These and other problems are addressed and solved according to the present invention, proposing a solution for making parts of an eyeglass or a mask, including the lenses, the bridge, and/or the nose pads, as well as the hinge and the hinging elements, of one-piece.

One-piece eyeglass or mask parts made according to the invention are described in the independent claim 1.

The method according to the invention is described in the independent claim 11.

The present invention will be now described, for illustrative but non-limiting purposes, with reference to a preferred embodiment schematically illustrated in the figures of the attached drawings, wherein:

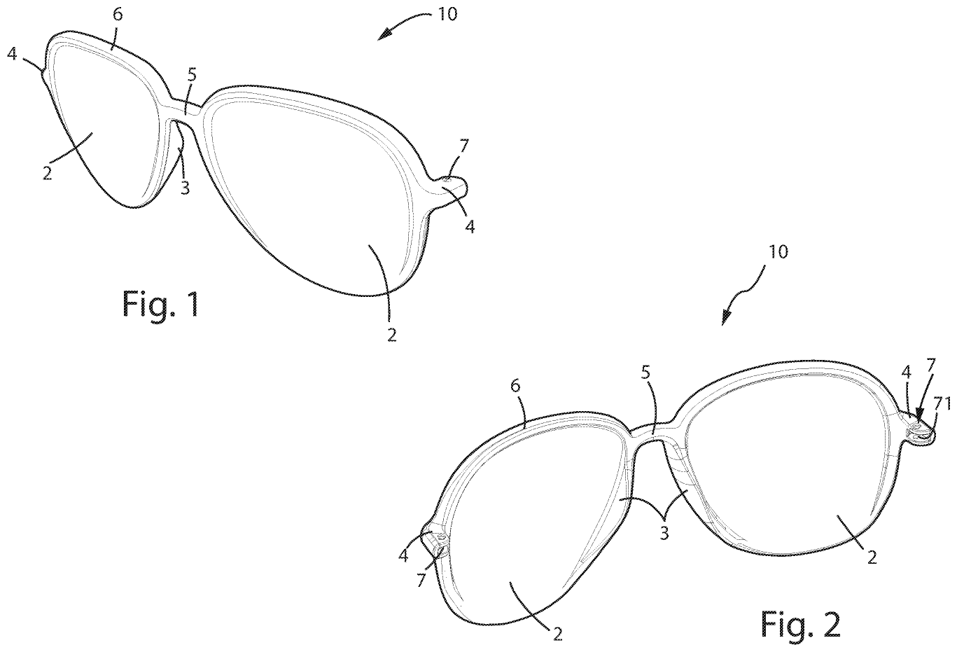

FIG. 1 is a front perspective view of one-piece eyeglass parts according to the invention;

FIG. 2 is a rear perspective view of one-piece eyeglass parts according to the invention;

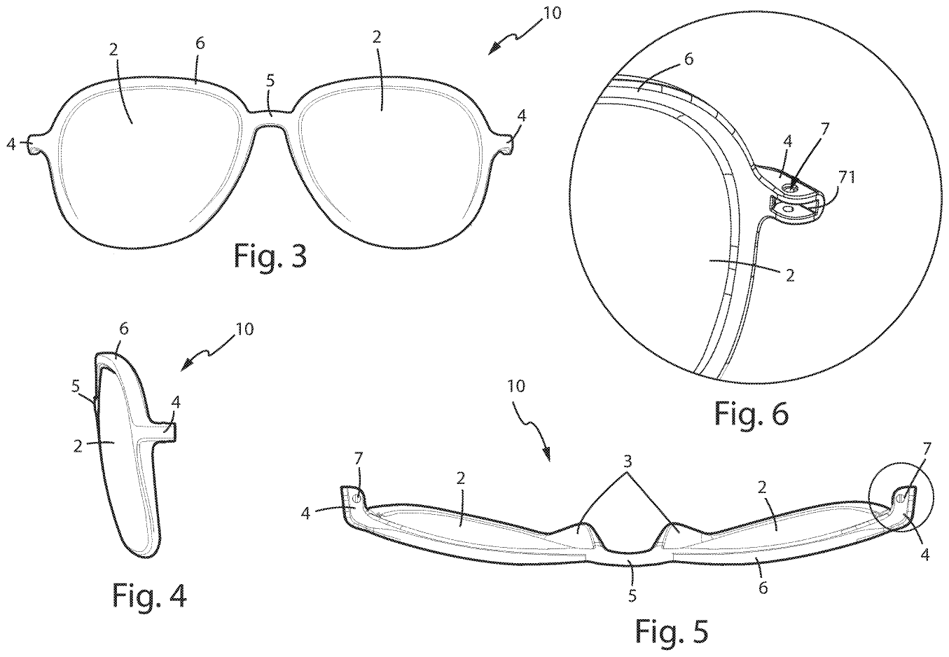

FIG. 3 is a front view of one-piece eyeglass parts according to the invention;

FIG. 4 is a side view of one-piece eyeglass parts according to the invention;

FIG. 5 is a top view of one-piece eyeglass parts according to the invention;

FIG. 6 shows the detail A of FIG. 5;

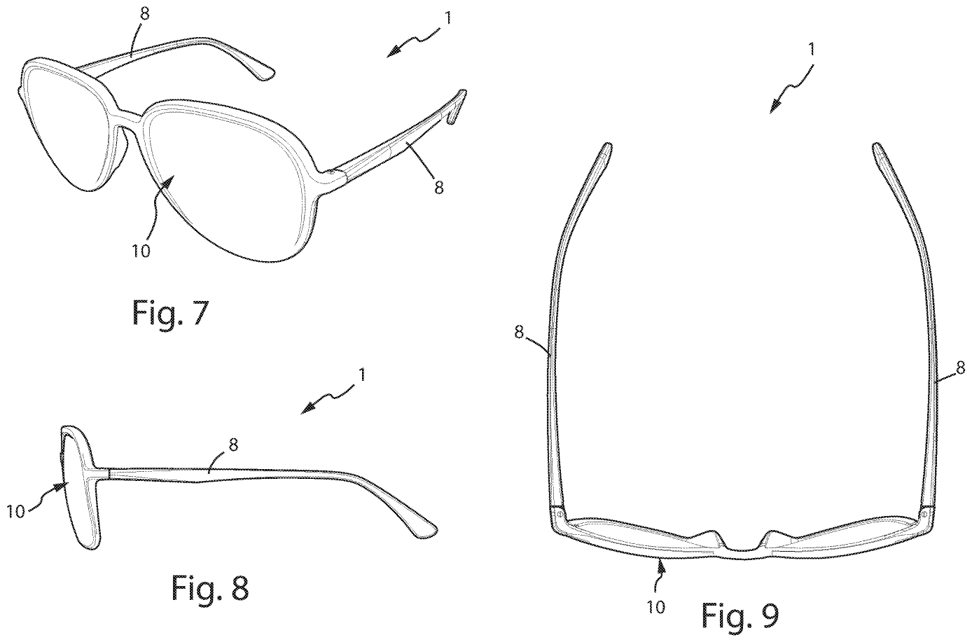

FIG. 7 is a perspective view of an eyeglass which comprises one-piece eyeglass parts according to the invention;

FIG. 8 is a side view of the eyeglass of FIG. 7; and

FIG. 9 is a top view of the eyeglass of FIG. 7.

In particular, by observing the figures of the attached drawings 1 to 9, an eyeglass (FIGS. 7-9), generally indicated by reference number 1, providing parts 10 (FIGS. 1-6) completely made by injection molding, can be observed.

All the parts 10 of the eyeglass 1 are made, in a preferred shape, by injection molding, including the lenses 2.

Therefore, in the step of producing the parts 10 of the eyeglass 1 of one-piece and by a single molding step, also the nose pads or nosepieces 3, the end pieces 4 for coupling the temples (not shown), the bridge 5, and the entire front 6 of the frame, as well as the hinge 7 itself and/or hinging elements 7, are made.

Hinge 7 and/or hinging elements 7 means both a temple/front connecting element and the respective seat 71. In particular, preferably the parts 10 of eyeglasses or mask comprise hinging elements 7 such as particularly seats 71 formed in each end piece 4, in which the components of the hinges are adapted to be inserted. For example, the seats 71 are adapted to accommodate the screws or other elements of the hinge, which can be made of materials equal to or even different from those of the parts 10 of eyeglasses or mask and connected to the parts 10 of eyeglasses or mask after making the parts 10 themselves. The temple/front connecting element and the respective seat 71 can be made of plastic material or metal material. The above-mentioned elements can be combined with each other according to all the possibilities, i.e., metal-metal, plastic-metal, metal-plastic, plastic-plastic.

The method according to the invention, which allows to obtain the parts 10 of the eyeglass 1 illustrated with all the elements 2-7 of one-piece and by a single molding, is characterized by a particular combination of the thickness of the material in the pertinent areas of the different parts, for also creating aesthetic effects such as shades and/or for conferring a particularly pleasing shape to the final object.

In an alternative embodiment, said parts 10 of the eyeglass 1 are made by casting. The material is not injected but casted by gravity in the dedicated mold.

According to the invention, a single material can be employed, a feature which allows to confer a greater environmental sustainability due to the improved possibility of end-of-life recycling, as well as the elimination of the componentry and/or the additional parts.

The temples 8 of the eyeglass 1 are coupled, by the hinge 7, after making the one-piece parts 10.

A large reduction of the production waste for making the finished eyeglass, as well as of the final weight of the object, is further obtained.

Furthermore, by this method, additional features, such as for example a functionalization, can be also attributed to the eyeglass 1. In the polar embodiment, the lens 2 of the eyeglass 1 is functionalized, for example comprising a polarizing layer.

Several treatments, such as, for exemplary but non-exhaustive purposes, anti-reflection, mirroring, anti-fog or anti-mist, hydrophobic and/or anti-stain, anti-scratch, anti-static treatments and other treatments known in the state of the art, can be applied to the lens 2 of the eyeglass 1. Said treatments can be applied on the outer surface (facing away from the wearer's eye) and/or on the inner surface (facing the wearer's eye) of the lens 2 of the eyeglass 1.

According to the invention, two-dimensional/three-dimensional objects can be incapsulated in one or more lenses 2. In particular, one or more lenses 2 can optionally comprise one or more two-dimensional or three-dimensional objects incapsulated therein, made of a material different from that the parts 10 of eyeglass or mask are made of.

According to the invention, functionalizing layers made of a material different from that the parts 10 of eyeglass or mask are made of can be integrated in the parts 10 of eyeglass or mask by lamination. According to such technique, one or more additional layers are applied on the inner or outer surface of the parts 10 of eyeglass or mask by the combined action of heat and pressure and the possible introduction of an adhesive layer.

The eyeglass 1 or mask can be made preferably in a single colour. Shading effects can be created by modulation of the thicknesses and/or by colouring techniques (e. g., colouring by immersion or dipping) known in the state of the art.

According to the invention, one or more decorative elements can be further associated to the parts 10 of eyeglass or mask. In particular, the decorative elements will be joined to the parts 10 of eyeglass or mask after making the same. For example, the finished eyeglass 1 can comprise one or more decorative elements glued to the lenses 2 or to the front 6.

With particular reference to the above-mentioned thicknesses, the molded eyeglass 1 provides contiguous areas of different thickness which must be sized so that the area with higher thickness differs from that with lower thickness by a maximum value of between 1.5 mm and 6 mm, preferably 2 mm.

Said contiguous areas must be joined by a junction having a radius of curvature between 0.5 and 5 mm, preferably 0.5 mm.

Such combinations of thicknesses and radii of curvature are designed and sized so as to confer the above-mentioned aesthetic effects but ensuring the processability of the product and preventing defects related to the processes of functionalization by immersion from occurring.

Regarding the materials, the eyeglass 1 or mask according to the invention is made of plastic material, in particular a plastic material belonging to the class of the thermoplastic or thermosetting polymers, preferably thermoplastic, having the lowest possible degree of crystallinity in order to ensure the transparency and the optical quality of the molded manufactured product. Alternatively, the same object can be made of bio-polymers, for further accentuating the sustainability features of the product.

The eyeglass 1 or mask can be made, still by the method according to the invention, also conferring the typical properties of an ophthalmic lens to the optical area.

The present invention has been described, for illustrative but non-limiting purposes, according to preferred embodiments thereof, but it should be understood that variations and/or modifications can be made by one skilled in the art without departing from the related scope of protection as defined in the attached claims.

1. Parts of eyeglass or mask made of one-piece, in bio-polymer or plastic monomaterial equal for all the parts of the eyeglass or mask, said parts comprising:
lenses, and/or nose pads or nosepieces, end pieces for coupling temples, a bridge, a front of the eyeglass frame or mask, hinges and/or hinging elements, and wherein contiguous areas of different thickness are provided, sized so that the area with higher thickness differs from that with lower thickness by a maximum value of between 1.5 mm and 6 mm, said contiguous areas being joined by a junction having a radius of curvature between 0.5 and 5 mm.

2. The parts of eyeglass or mask made of one-piece by a single injection molding step.

3. The parts of eyeglass or mask made of one-piece according to claim 2, wherein said plastic material belongs to a class of the bio-polymers or thermosetting or thermoplastic polymers having the lowest possible degree of crystallinity in order to ensure transparency and optical quality of the molded manufactured product.

4. The parts of eyeglass or mask made of one-piece by a casting process.

5. The parts of eyeglass or mask made of one-piece according to claim 1, wherein the difference between the area with higher thickness and that with lower thickness is 2 mm.

6. The parts of eyeglass or mask made of one-piece according to claim 1, wherein said radius of curvature of said junction areas is equal to 0.5 mm.

7. The parts of eyeglass or mask made of one-piece according to claim 1, wherein said lenses are functionalized.

8. The parts of eyeglass or mask made of one-piece according to claim 7, wherein said functionalization provides a polarizing layer.

9. The parts of eyeglass or mask made of one-piece according to claim 1, wherein said parts of eyeglass or mask are subjected to anti-reflection, mirroring, anti-fog or anti-mist, hydrophobic and/or anti-stain, anti-scratch, anti-static treatments and/or other type of treatment.

10. The parts of eyeglass or mask made of one-piece according to claim 1, wherein said lenses are ophthalmic lenses.

11. A method for making parts of an eyeglass or mask in one-piece, in bio-polymer or plastic monomaterial equal for all the parts of the eyeglass or mask, said parts comprising lenses, and/or nose pads or nosepieces, end pieces for coupling temples, a bridge, a front of the eyeglass frame or mask, hinges and/or hinging elements, said method by making parts of eyeglass or mask wherein contiguous areas of different thickness are provided, sized so that the area with higher thickness differs from that with lower thickness by a maximum value of between 1.5 and 6 mm, said contiguous areas being joined by a junction having a radius of curvature between 0.5 and 5 mm.

12. The method according to claim 11, wherein said method provides to make said parts of eyeglass or mask of one-piece by a single injection molding step or by a casting process.

13. The method according to claim 11, wherein a difference between the area with higher thickness and that with lower thickness is 2 mm.

14. Method The method according to claim 11, wherein said radius of curvature of said junction areas is equal to 0.5 mm.

15. The method according to claim 11, wherein said lenses are subjected to functionalization.

16. The method according to claim 15, wherein said functionalization provides a polarizing layer.

17. The method according to claim 11, wherein said parts of eyeglass or mask are subjected to anti-reflection, mirroring, anti-fog or anti-mist, hydrophobic and/or anti-stain, anti-scratch, anti-static treatments and/or other type of treatment.

18. The method according to claim 11, wherein said lenses are ophthalmic lenses.

19. The method according to claim 12, wherein a difference between the area with higher thickness and that with lower thickness is 2 mm.

20. The method according to claim 12, wherein said radius of curvature of said junction areas is equal to 0.5 mm.
